(19) United States
(12) Patent Application Publication
(10) Pub. No.: US 2007/0082229 A1
(43) Pub. Date: Apr. 12, 2007

(54) Biocompatible cemented carbide articles and methods of making the same

(76) Inventors: Rajini P. Mirchandani, Hampton Cove, AL (US); Mala P. Mirchandani, Clermont, FL (US)

Correspondence Address: Rajini P. Mirchandani, 11323 Pampass Pass, Houston, TX, 77095, US

(21) Appl. No.: 11/247,533

(22) Filed: Oct. 11, 2005

(51) Int. Cl. B32B 9/00; C22C 32/00

(52) U.S. Cl. 428/698; 428/701; 419/13

(57) ABSTRACT

This invention relates to cemented carbide articles that are characterized by substantially improved biocompatibility with human skin, tissue, organs, etc., compared with articles made from conventional cemented carbides. The essential feature of these improved biocompatible cemented carbide articles is a binder-depleted zone at and near the exposed surfaces of the articles. By depleting the binder (which mainly consists of Co and/or Ni, as well as their alloys) at and near the surface, the toxic effects of Co and Ni (known carcinogens), as well as the allergic reactions that these metals can cause when in contact with human skin, are eliminated. By depleting the binder only at and near the surface, the bulk properties of the cemented carbide article are not compromised or altered in any manner. Applications of these binder-depleted cemented carbides could include articles that human skin may experience prolonged exposure to, for example, jewelry articles such as rings, bracelets, bangles, chains, necklaces, pendants, watches, watch cases, watch straps, etc. In addition, the cemented carbides of this invention may be used in applications where the article comes directly in contact with human skin, tissue, organs, etc. such as surgical and other medical instruments, razor blades, etc. Also, other applications could include knives, tools, dies, and other wear components that are used to process and handle, and hence, come into direct contact with materials meant for human consumption and/or ingestion. Examples of such materials include foodstuffs and pharmaceuticals.

### FIELD OF THE INVENTION AND COMMERCIAL APPLICABILITY

This invention relates to providing cemented carbide articles that are relatively free from causing skin allergies and other health hazards when they come into contact with human skin or tissue, as well as with as with materials that are meant for human or animal ingestion or consumption. Examples of the types of articles covered by this invention include jewelry articles such as rings, bracelets, bangles, pendants, chains, watchcases and straps, pens, etc. Another example of the articles covered by this invention are razor blades employed for the removal of facial and body hair in humans. In addition, articles such as medical and surgical knives and instruments used during surgical procedures on humans and animals are also covered by this invention. This invention also covers knives and other cutting implements as well as tools and dies or any other cemented carbide components that may come into contact with foodstuffs as well as pharmaceuticals, etc.

### BACKGROUND OF THE INVENTION

Cemented carbides are a special class of ultrahard metal-matrix composites comprising of one or more of the carbides of the transition metals belonging to groups IVB, VB, and VIB of the periodic table (Ti, V, Cr, Zr, Hf, Mo, Nb, Ta, and W), cemented together by Co, Ni, or Fe (or alloys of these metals). The commercial importance of cemented carbides stems from the very attractive combinations of strength, toughness, and, in particular, abrasion resistance that these materials exhibit. Cemented carbides presently find extensive applications in tools for metalcutting and metalforming, oil/gas drilling and mining, woodworking, etc., and have been employed in these applications for over 50 years. A comprehensive review of cemented carbide materials, available grades, applications, manufacturing methods, etc. may be found in “Handbook of Hardmetals and Hard Materials”, Sixth Edition, by Kenneth Brookes, published by International Carbide Data, Hertfordshire, UK, as well as in “Cemented Carbides”, by Paul Schwarzkoff and R. Kieffer, published by The MacMillan Company.

Cemented carbides occupy a very unique position within the hierarchy of structural materials since they possess many properties that are characteristic of both metals and ceramic materials. This is because transition metal carbides, which form the majority component of cemented carbides (typically from 50 to 98% by weight), have the unique distinction in that they can be classified as either metals or ceramics. For instance, transition metal carbides possess very high melting points that are comparable with those of the highest melting point ceramics (typically greater than about 2500° C.). Because of their high melting points, transition metal carbides exhibit some properties that are characteristic of ceramics, for example, high chemical stability and relative inertness when in contact with other materials, including human skin and tissue. In general, transition metal carbides can be classified as biocompatible materials. Just like ceramics, transition metal carbides are also characterized by very high hardness and abrasion resistance levels.

However, In contrast with ceramics, transition metal carbides exhibit many properties that are characteristic of metals, for example, high thermal conductivity, relatively high thermal expansion, the ability to exhibit limited plastic deformation when stressed, the ability to take on a highly polished metallic luster, etc. The reason for this unique behavior on the part of transition metal carbides stems from the consideration that while the inter-atomic bonding forces in the case of ceramics are based either on covalent or ionic bonding, the inter-atomic bonding forces in the case of transition metal carbides are metallic bonding.

The unique characteristics of transition metal carbides were recognized over 100 years ago. It was quickly recognized that, because of their extremely high melting points, it would be very difficult to fabricate useful articles from transition metal carbides using conventional cast-and-wrought metallurgy methods. Early development of structural materials based on transition metal carbides thus focused on hot pressing particles of transition metal carbides at very high temperatures. Again, however, it was quickly recognized that it would be difficult to produce articles with adequate strength unless hot pressing temperatures in excess of 3000° C. were employed. The hot pressing technique was thus considered impractical.

Additional work led to the development of “cemented” carbides during the early part of the twentieth century. It was realized that by creating an intimate mixture of transition metal carbide particles, along with particles of a lower melting point metal, consolidating the powder blend into articles of defined shape and size to form a powder compact, and heating the compact to a high temperature (typically in the 1300 to 1600° C. range), it was possible to create an article with exceptional abrasion resistance, strength, and fracture toughness. The process of heating the compact to a high temperature is often referred to as sintering. During the sintering step the metal particles react with the transition metal carbide particles to form a relatively low melting-point liquid phase, which in turn fills all the void spaces within the powder compact to yield an essentially fully dense material. The sintering process for cemented carbides is also commonly referred to as liquid phase sintering (LPS). The manufacturing processes for cemented carbide materials are comprehensively described in “Cemented Carbides” by P. Schwarzkoff and R. Kieffer, published by The MacMillan Company.

Over the years extensive research work has shown that the best combinations of properties are obtained when metals such as the Fe-group metals, namely, Co, Ni, and/or Fe, are used as the binder metal in combination with transition metal carbides. This is because these metals are capable of wetting the transition metal carbide particles during the liquid phase sintering (LPS) process, thus being able to fill the voids within the powder compacts, resulting in relatively void-free, strong, and hard cemented carbide materials. Virtually all commercially important cemented carbide materials are based on transition metal carbides combined with Co, Ni, and/or Fe, or alloys of these metals, either in combination with each other, or additional alloying elements. Common alloying additions include Cr, Mo, W, Ru, etc.

Over the past 60 to 70 years many different grades of cemented carbides have been developed that are suitable for a host of applications. While grades from virtually all of the transition metal carbides in combination with all of the Fe-group metals (and their alloys) have been made and sold, the most important grades, from a commercial standpoint, are those based on tungsten carbide (WC) as the majority transition metal carbide component, combined with cobalt (Co) and/or nickel (Ni) as the majority binder component. Different grades, aimed at achieving different combinations of properties, are generally developed by varying the weight or volume fractions of the transition metal carbide (and hence, the metallic binder) component, the average grain size of the transition metal carbide phase, the types and relative amounts of the transition metal carbides present, and/or the composition of the metallic binder.

As stated earlier, most of the applications of cemented carbides have been limited to industrial applications including tools for metalcutting and other structural materials such as wood, plastics, composites, etc., tools and dies for forming structural materials, tools for earth boring, and many other miscellaneous applications requiring abrasion and erosion resistance coupled with high strength and toughness. Cemented carbides have rarely been employed in applications where the articles may come into contact with human skin or tissue, or where the cemented carbide articles may be used to process materials that may be ingested or consumed by human beings or animals. The primary reason why cemented carbides are rarely, if ever, used in such applications is because the metallic binder components (Co and/or Ni) are known carcinogens, and prolonged direct contact of cemented carbides with the human skin is widely known to cause allergies and skin rashes. Further, if cemented carbide components are used to process materials meant for human consumption or ingestion, there is always a possibility that some of the Co and/or Ni present at the surface of the cemented carbide component will end up in the material to be consumed by humans, either by chemical leaching or mechanical abrasion or erosion. The literature is replete with the effects of Co and Ni on human health. Indeed, the material safety data sheets (MSDS) issued by all cemented carbide manufacturers explicitly warn about the health dangers of coming into contact with cemented carbides, and, in particular, the binder phase of the cemented carbide material.

Because of their exceptional durability, resistance to abrasion and scratching, ability to take on a very high polish, ability to retain sharp edges during extended use, etc., there are many applications where it would normally be very attractive to employ cemented carbides. However, because of the toxic nature of the binder alloys present in cemented carbides, they are currently not employed in those applications. Examples of such applications include jewelry articles such as rings, bracelets, pendants, chains, earrings, watch cases and straps, fountain and ball point pens, mechanical pencils, etc. Other applications include razor blades for facial and body hair removal in humans. Also, other applications include surgical knives, tools and instruments employed by surgeons, dentists, and medical doctors during surgical procedures on humans and animals. In addition, cemented carbides could be utilized as knives, tools, dies, wear parts, etc. during the processing of materials such as foodstuffs and pharmaceuticals meant for human or animal consumption. The partial list of applications noted above is only a representative sample of possible new applications.

While it is recognized that the presence of a metallic binder based on Co, Ni, and/or Fe (or alloys thereof) is necessary in order to develop the exceptional properties and durability of cemented carbides, it is clear that these materials would be suitable for employment in the applications noted in the preceding paragraph only if the toxic nature of the binder could somehow be eliminated or, at least, minimized. This would create many new applications for cemented carbides. There is thus a great need for providing a method of eliminating the harmful toxic effects of the binder alloys in cemented carbide articles without sacrificing the exceptional combinations of abrasion resistance, strength, and toughness that these materials offer.

### SUMMARY OF THE INVENTION

We have discovered that one way to eliminate or minimize the toxic effects of the binder alloys in cemented carbides, without compromising their inherent abrasion resistance, strength, and toughness, is to greatly reduce the concentration of the binder at and near the surface(s) of the cemented carbide article, without altering the binder concentration in the bulk of the material. In cemented carbide articles having a binder-depleted zone at and near all exposed surfaces very little, if any, of the binder alloy can be expected to come into direct contact with human skin or tissue, hence drastically reducing, if not eliminating, the toxic effects of the binder alloy. Furthermore, it can be expected that such binder-depleted cemented carbide articles employed in food or pharmaceutical processing will tend not to contaminate the foodstuffs or pharmaceuticals with the binder alloy. The biocompatible cemented carbide articles of this invention are thus based on a binder-depleted zone at and near their surfaces. In the cemented carbide articles of this invention the concentration of the binder alloy is greatly lowered only at and close to the surface, but remains the same as the nominal concentration within the bulk of the material.

Embodiments of this invention include all types of cemented carbide articles that come directly or indirectly into contact with human skin, flesh, tissue, organs, etc., and which have a binder-depleted zone at and near all exposed and/or working surfaces. Embodiments of this invention also include binder-depleted cemented carbide articles that are employed in the processing or handling of materials meant for human or animal consumption or ingestion. Examples of some of the applications of such articles include, but are not limited to, jewelry articles (rings, bracelets, pendants, chains, watchcases and straps, fountain and ballpoint pens, mechanical pencils, etc.), razor blades, surgical knives, tools, and instruments used to perform surgery on humans and animals, as well as culinary knives used to process foodstuffs, cutlery used in the consumption of food by humans, tools and dies used to process pharmaceuticals, etc.

For the purpose of this invention, cemented carbides are defined as comprising between 50 and 98% by weight of one or more of the carbides of the transition metals (Ti, V, Cr, Zr, Mo, Nb, Hf, Ta, and W), as well as solid solutions of different transition metal carbides, with the balance being a metallic binder comprising of Co, Ni, and/or Fe (or alloys of these metals). The binder may additionally contain elements such as Cr, W, Mo, Ru, etc. as alloying elements.

Embodiments of this invention also include binder-depleted cemented carbide articles based on monolithic, composite, gradient, as well as hybrid microstructures.

Embodiments of this invention further include assemblies of binder-depleted cemented carbide components with components made of other materials including metals and alloys, wood, plastics, ceramics, precious gems and stones, etc. The assemblies may be made by mechanical means (for example, a screwed or bolted joint, press or shrink fit, etc.), chemical means (for example, epoxy, glue, etc.), welding or brazing, injection molding, powder metallurgy, casting, etc

Embodiments of this invention also include binder-depleted cemented carbides on which hard coatings have been applied using techniques such as chemical vapor deposition (CVD), physical vapor deposition (PVD), etc. Embodiments include coatings of compounds such as TiN, TiCN, Al₂0₃, CrN, HfN, TiAlN, diamond like coating (DLC), etc. Embodiments additionally include either single coatings of one compound or multiple coatings of one or more compounds.

Embodiments of this invention include binder-depleted cemented carbides in which the binder depleted zone has been impregnated with other materials (for example, epoxy, oils, polymers, or other organic or inorganic compounds) or infiltrated with other metals (for example, precious metals such as gold, silver, platinum, etc. as well as with alloys of other metals such as copper, aluminum, titanium, etc.)

Embodiments of this invention also include methods of fabricating cemented carbide articles having a binder-depleted zone at and near the surface of the article.

### BRIEF DESCRIPTION OF THE FIGURES

FIG. 1(a) is a photomicrograph showing the microstructure of a WC-Co cemented carbide based on an average WC grain size of about 5.0 microns and a WC content of 75 wt. %.

FIG. 1(b) is a photomicrograph showing the microstructure of a WC-Co cemented carbide based on an average WC grain size of about 0.8 micron and a WC content of 6-wt. %.

FIG. 2 is a photomicrograph showing the microstructure of a WC-Co cemented carbide containing additions of TiC and TaC.

FIG. 3 is a photomicrograph showing the microstructure of a surface binder-depleted cemented carbide.

FIG. 4 is a photomicrograph showing the microstructure at the interface between the binder-depleted zone and the bulk material.

FIG. 5 is a photomicrograph showing the microstructure in a WC-Co-0.5Cr cemented carbide that was immersed in 10% HCl at 60° C. for 72 hours.

FIG. 6 is a photomicrograph showing the microstructure in a WC-Co-0.5Cr cemented carbide that was immersed in 20% HNO₃ at 60° C. for 72 hours.

FIG. 7 is a photomicrograph showing the microstructure in a WC-Co-0.5Cr cemented carbide that was immersed in 5% H₂SO₄ at 60° C. for 72 hours.

FIG. 8 is a photomicrograph showing the microstructure of a multi-layer coating applied on a cemented carbide substrate.

FIG. 9(a) is a schematic representation of a multi-layer, multi-compound, and multi-color coating on a cemented carbide material. FIG. 9(a) also depicts how portions of the coating can be removed by a conical-shaped grinding wheel.

FIG. 9(b) illustrates how selective removal of portions of the coating in FIG. 9(a) can be used to create a multi-colored geometric circular pattern.

FIG. 10(a) is a schematic representation of a multi-layer, multi-compound, multi-color coating on a cemented carbide material. FIG. 10(a) also depicts how portions of the coating can be selectively removed by a tapered grinding wheel.

FIG. 10(b) illustrates how selective removal of portions of the coating in FIG. 10(a) can be used to create a multi-colored geometric straight-line pattern.

FIG. 11 (a) schematically illustrates a typical monolithic cemented carbide microstructure.

FIG. 11 (b) schematically illustrates a typical composite cemented carbide microstructure.

FIG. 11(c) schematically illustrates a typical gradient cemented carbide microstructure.

FIG. 11(d) schematically illustrates a typical hybrid cemented carbide microstructure.

### DETAILED DESCRIPTION OF THE INVENTION AND PREFERRED EMBODIMENTS

Embodiments of the present invention relate to cemented carbide articles having a zone at and near all surfaces of the article that is depleted of the binder. Embodiments of this invention also include methods of fabricating cemented carbide articles with binder-depleted zones at and near the surface. Embodiments of this invention include articles that are assemblies of binder-depleted cemented carbide articles joined or attached to articles made of other materials including metals and alloys, wood, plastics, ceramics, etc. Embodiments further include binder-depleted cemented carbide articles that have been coated with hard coatings such as TiN, TiCN, TiAlN, Al₂O₃, CrN, HfN, DLC, etc. using commonly used techniques such as chemical vapor deposition (CVD), physical vapor deposition (PVD), and variants thereof. Embodiments include single coatings or multiple coatings of any or all of the types of compounds noted. Embodiments of this invention also include binder-depleted cemented carbide articles wherein the binder-depleted zone has been impregnated or infiltrated with epoxy, teflon, oils, polymeric materials, other organic or inorganic compounds, or precious metals (Au, Pt, Ag, Pd, etc.) and their alloys, or Cu, Ti, Al, and their alloys, etc.

Conventional cemented carbides are relatively mature materials that have been made and sold commercially for the past 6 to 7 decades. They find extensive applications as tools for cutting virtually all materials of construction (metals, wood, plastics, masonry, etc.). They are also extensively used as earth boring tools during oil and natural gas exploration, tools and dies for forming metals, and many miscellaneous wear applications. Cemented carbides consist essentially of grains of hard transition metal carbides that are cemented together by a softer metallic binder. From a commercial standpoint the most important cemented carbides are those based on WC as the hard transition metal carbide cemented together by Co and/or Ni as the metallic binder. Cemented carbides with different properties can be made by varying the average grain size of the WC phase and/or by varying the weight or volume fraction of the hard transition metal carbide phase. The practical limits for average WC grain size range between about 0.1 micron up to about 25.0 microns. Also, the practical limits for the weight fraction of the transition metal carbide range from about 50% up to about 98%. Additions of other transition metal carbides such as TiC, TaC, NbC, VC, etc. are sometimes made to enhance certain properties. Alloying additions of Cr, Mo, Ru, etc. may also be added to the metallic binder.

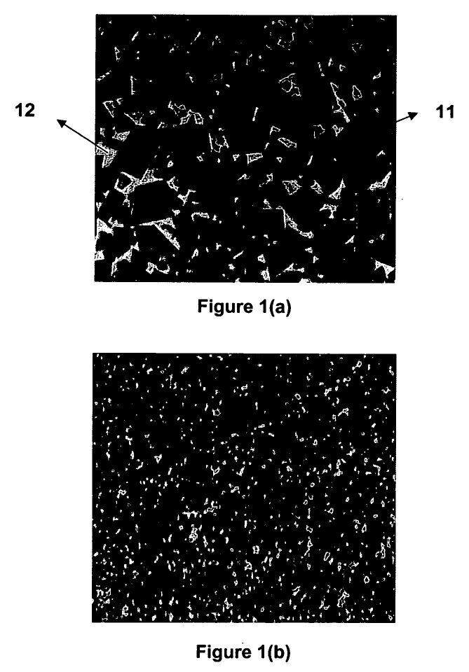

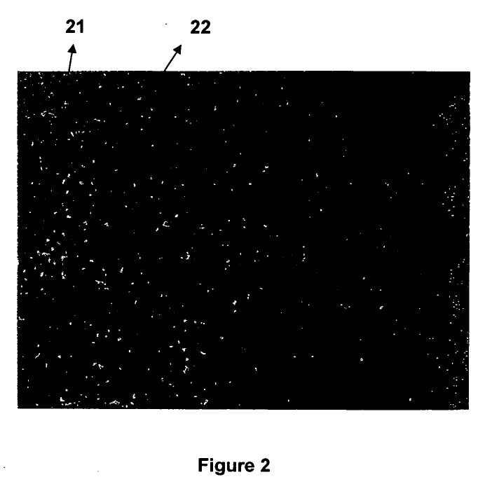

FIGS. 1(a) and 1(b) illustrate the typical microstructures of WC-Co based cemented carbides. The dark gray WC grains 11 (also referred to as the discontinuous phase) are cemented together by the light gray Co binder phase 12 (also referred to as the continuous phase). FIG. 1(a) shows a cemented carbide with a relatively coarse grain structure (average WC grain size about 5.0 microns) and a relatively low WC weight content (about 75%). On the other hand, FIG. 1 (b) illustrates the microstructure of a WC-Co material with a relatively fine grain structure (average WC grain size about 0.8 micron) and a relatively high WC weight content (about 94%). In addition, FIG. 2 illustrates the microstructure of a WC-Co based cemented carbide containing additions of TiC and TaC. In FIG. 2 the WC grains 21 as well as the TiC and TaC grains 22 are cemented together by the Co phase. It should be noted that the TiC and TaC phases are mutually soluble in each other, and thus appear as a single solid solution phase 22 in FIG. 2. Embodiments of the present invention include binder-depleted cemented carbide articles that are based on any and all types of cemented carbides regardless of the type(s) of transition metal carbides present, the amount of transition metal carbide or binder present, the average grain size of the transition metal carbides, or composition of the binder.

Methods of manufacturing conventional cemented carbides have been described in great detail in many technical publications that are widely available. Briefly, the manufacturing process firstly involves creating a very intimate blend of fine particles of transition metal carbides and the binder metal (Co, Ni, and/or Fe, or alloys thereof). This is often accomplished by ball-or attritor-milling the fine particles together. The next step involves consolidating the powder blends to form articles of the required shape and size. Powder consolidation can be performed by compaction using rigid dies in mechanical or hydraulic presses, or using flexible tooling in wet-bag or dry-bag isostatic presses. Powder consolidation can also be accomplished by extruding a blend of the metal particles and a plastic binder. In addition, powder consolidation can be accomplished by injection molding a blend of powder particles and a plastic binder using rigid molds. Following consolidation, the powder compacts can be shaped using conventional machining techniques such as turning, milling, drilling, shaping, waterjet machining, etc. in order to provide shape details that are difficult to incorporate during powder pressing or extrusion. Shaping of the powder compacts may be performed with the compacts in the as-green (i.e., as consolidated) or presintered condition. Presintering typically involves heating the compact to an intermediate temperature (often in the 500 to 1000° C. range) in order to provide it with some strength, and thus, facilitate the shaping process. The powder compacts are then heat-treated at high temperatures (1300 to 1600° C.), with the temperature depending on the composition of the cemented carbide. This heat-treatment is commonly referred to as sintering. Sintering is typically performed in vacuum furnaces or in over-pressure furnaces (also commonly known as Sinter-Hip). During Sinter-Hip the parts are subjected to an atmosphere of high pressure argon (typically between 200 and 1,500 psi) when the parts reach the highest sintering temperature. Sinter-Hip ensures that the last vestiges of porosity are removed within the cemented carbide material. Following sintering the parts can be ground (using diamond-plated wheels, resin-bonded diamond wheels, or metal-bonded diamond wheels), electro-discharge machined (EDM), ultrasonic machined, laser machined, polished (using diamond paste), hard-coated using CVD, and/or PVD techniques (as well as variants), etc., as needed to fabricate the finished product. The manufacturing processes summarized above allow for the fabrication of cemented carbide articles with a very wide range of sizes, shapes, surface finishes, textures, features, and properties. Embodiments of the present invention include binder-depleted cemented carbide articles processed using any or all commonly employed methods of fabricating and finishing cemented carbides, including those noted above.

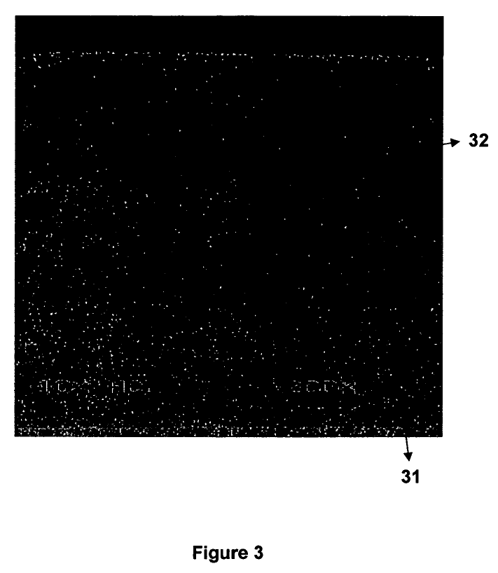

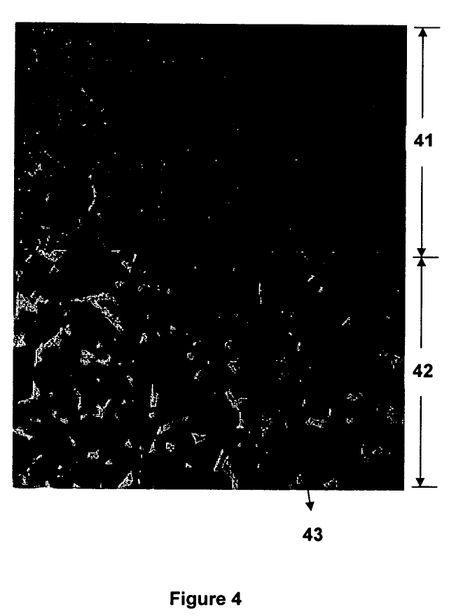

As may be observed in FIGS. 1(a), 1(b), and 2, the continuous binder phase is very uniformly mixed with the discontinuous hard phase. The binder phase is thus present at all exposed surfaces of the cemented carbide material. On any surface, the area fraction of the binder phase is essentially the same as the volume fraction of the binder phase in the bulk. Embodiments of the present invention include cemented carbide articles from which most of the binder has been removed within a zone at and near the surface of the article. FIG. 3 illustrates the microstructure of such a binder-depleted cemented carbide material. In the binder-depleted zone 32, the majority of the Co binder has been leached out of the material leaving behind a skeleton of WC grains. FIG. 4 shows a higher magnification view of the interfacial region showing the binder-depleted zone 41 and the bulk material 42. The interface between the two zones 43 is also clearly observed. The only binder present in the binder-depleted zone is in the extremely thin interfacial regions where the WC grains are contiguous, i.e., come very close to touching one another. The thickness of these interfacial binder regions is only of the order of a few atomic layers. Since the only portion of the binder that has been depleted was originally present as “pools” or “lakes” within the relatively large interstitial spaces between the grains, the strength of the binder-depleted cemented carbide is essentially the same as that of the bulk material. This is because the transition metal carbide grains are, in general, much harder and stronger than the soft metallic binder. In reality, the only portions of the binder that hold the carbide grains together and provide strength to the composite material are the thin films of binder present between contiguous carbide particles. The surfaces of the binder-depleted cemented carbide articles of this invention will have very little, if any, binder present on them since all the binder “pools” and “lakes” have been eliminated. Since the transition metal carbide grains are biocompatible, and there is very little, if any, binder present at and near the surfaces of the binder-depleted materials, the cemented carbide articles of this invention have substantially improved biocompatibility compared to conventional cemented carbides.

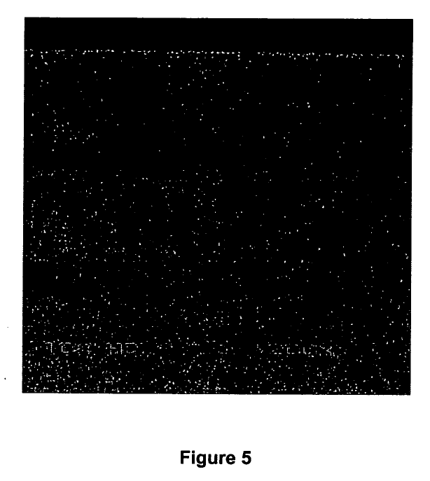

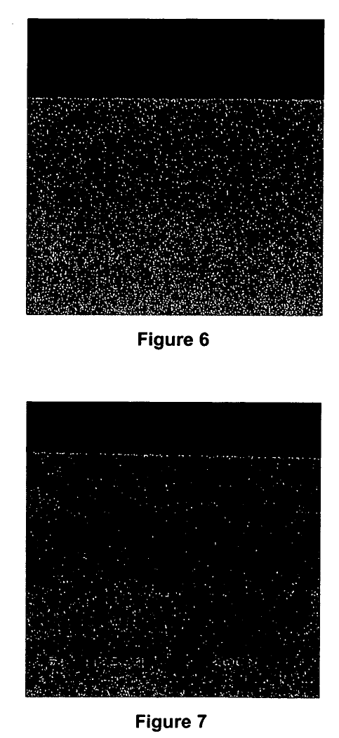

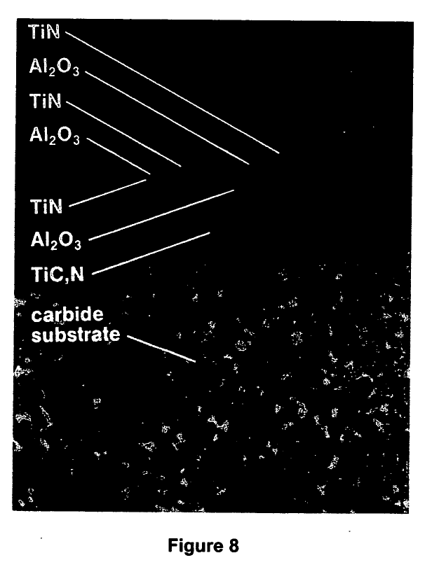

One method of removing the binder at and close to the surface of a cemented carbide article involves immersing the article in virtually any inorganic acid (for example, HCI, HNO₃, H₂SO₄, etc.), causing the dissolution, and hence the leaching out, of the binder. The depth of binder removal will depend upon the composition of the binder, type of acid employed, the molar concentration of the acid, as well as the temperature to which the article and the acid solution are exposed during the immersion process. For example, FIGS. 5, 6, and 7 illustrate the depth of attack on a WC-6Co-0.5Cr cemented carbide by dilute HCI, HNO₃, and H₂SO₄ with varying molar concentrations of the acid solutions, and immersed for 72 hours at a temperature of 60° C. The reader can thus easily appreciate that the depth of binder removal is easily controllable by varying the type of leaching medium, its concentration, and temperature. Embodiments of the present invention include cemented carbide articles with binder-depleted zones ranging from 1.0 micron up to about 1000.0 microns, with the depth of the binder-depleted zone selected being based upon the application. Embodiments of the present invention further include binder-depleted cemented carbide articles wherein the concentration of the binder in the binder-depleted zone is less than 25%, and preferably less than 10%, of the nominal binder concentration in the bulk of the material.

Besides inorganic acids, solutions of a number of compounds that dissolve Co, Ni, or Fe-based alloys may be used to leach out the binder at and near the surface of cemented carbides. Examples of such compounds include ferric chloride, sodium persulfate, sodium tetrafluoroborate, sodium citrate, sodium pyrophosphate, boric acid, etc. In addition to chemical leaching methods, thermal methods may also be used. For example, since the melting point of the binder is much lower than transition metal carbides, the binder in a cemented carbide material can be depleted at and near the surface by exposing the article to a high temperature. This will result in the evaporation of the binder, thus leaving behind a binder-depleted surface zone. In general, anyone skilled in the art will recognize that there exist several ways to remove a thin layer of the binder at and near the surface of the cemented carbide article. Any such technique can be employed without violating the spirit of this invention. Embodiments of this invention thus include binder-depleted cemented carbides without regard to the technique employed to remove the binder. Further, embodiments of this invention include binder-depleted cemented carbide articles wherein the binder removal process can occur at any stage in the manufacturing process after the article has been sintered.

Embodiments of this invention further include binder-depleted cemented carbide articles that have been coated with hard compounds such as TiN, TiCN, TiAlN, Al2O3, CrN, HfN, Diamond-Like Coating (DLC), etc. applied using techniques such as chemical vapor deposition (CVD), physical vapor deposition (PVD), and variants thereof. The practice of applying hard coatings on cemented carbides has been widely practiced for over 2 decades and a vast variety of coating techniques and coating types have been developed and applied. The literature is replete with information on coating techniques and types. For this reason, it is not necessary to discuss the techniques that can be employed and the coating types that can be applied in this disclosure. The current invention relates to coatings applied only on the special binder-depleted cemented carbides of interest. Embodiments of the present invention thus include coated binder-depleted cemented carbides regardless of the coating technique employed or the coating type applied.

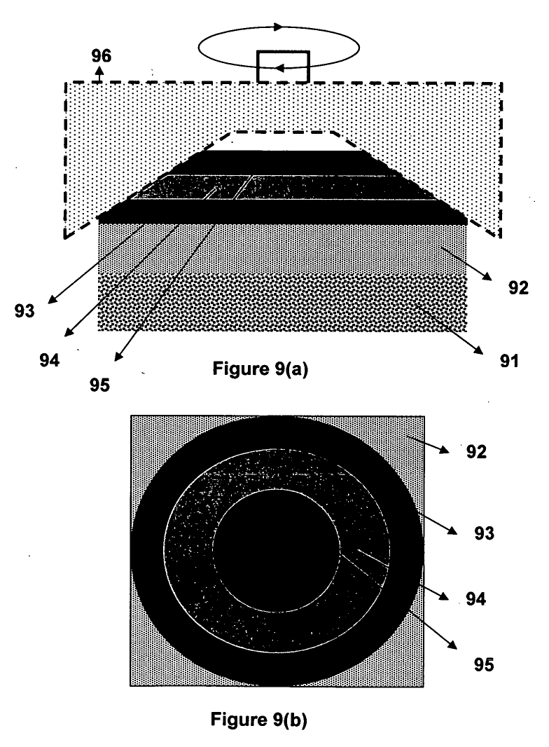

Coatings on cemented carbides can be applied either singly (i.e., one compound) or as multiple coatings (i.e., multiple layers of one or more compounds). FIG. 8 illustrates a multi-layer coating applied on a standard cemented carbide substrate. Coatings on cemented carbides are employed primarily to provide a surface with a low coefficient of friction as well as to increase surface abrasion resistance. Since the coatings come in many different colors and textures, they can also be employed for decorative purposes. For example, while TiN is gold in color, TiCN can be made in many different colors depending upon the carbon-to-nitrogen ratio employed during the coating process. Coatings of TiC, Al₂O₃, TiAIN, and DLC are generally dark gray to black in color. Embodiments of this invention include single as well as multiple coatings on binder-depleted cemented carbide articles.

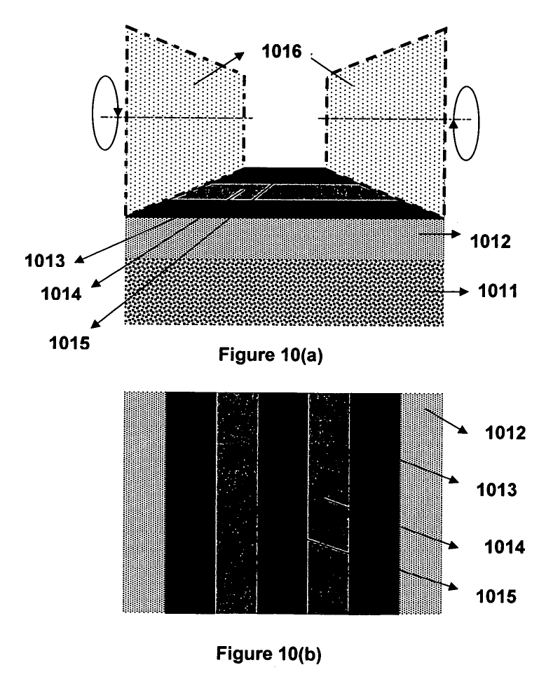

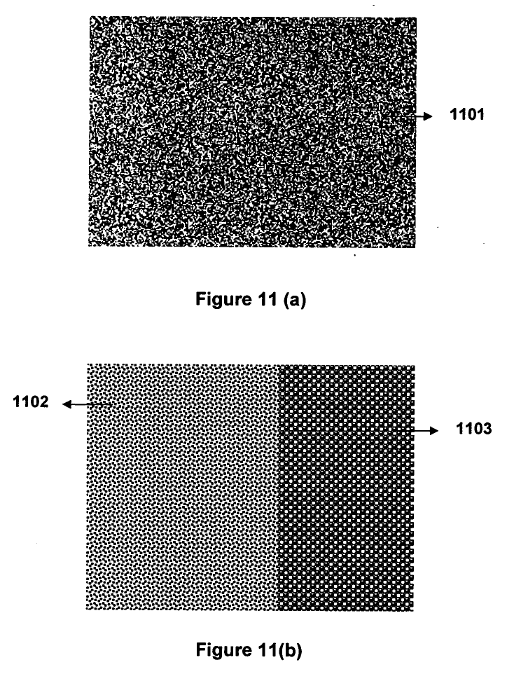

An example of a novel way that multiple coatings on cemented carbide articles can be used for decorative purposes is illustrated in FIGS. 9(a), 9(b), 10(a) and 10(b). After application of a multi-layer coating consisting of different colored compounds 93, 94, and 95 as shown in FIG. 9(a), material is carefully removed from the surface of the article by a suitably shaped grinding wheel 96 to reveal a different colored pattern as shown in FIG. 9(b), in which a circular geometrical pattern is shown. Similarly, by using a different shaped grinding wheel, it is possible to create other types of patterns, for example a straight-line pattern as illustrated in FIGS. 10(a) and 10(b. It should be noted that the examples provided here are merely for the purpose of illustrating some of the possible ways that coatings can be employed for decorative purposes. Anyone skilled in the art will recognize that many variations of the central theme presented here exist, and the employment of any of those variations does not violate the spirit of this invention. Embodiments of this invention include binder-depleted cemented carbides on which multi-layer coatings have been applied, followed by selective removal of the coating layers to reveal different geometric patterns and color combinations.

Following the binder removal process in the binder-depleted cemented carbide articles of this invention, a fine interconnected pore network is typically left behind at and near the surface of the article. In order to further improve biocompatibility, and/or improve the lubricity and thus provide a self-lubricating feature, and/or enhance any other property or characteristic of the articles of this invention, the fine pore structure near the surface can be impregnated with materials such as teflon, epoxy, or a variety of other polymeric materials, etc. In addition, the pore structure may be infiltrated with lower melting point metals and alloys including the precious metals (Au, Pt, Ag, etc.) and their alloys, as well as Cu, Al, Ti, etc. and their alloys. In general, the pore structure can be infiltrated or impregnated with a very wide range of materials employing a wide range of techniques including vacuum impregnation, direct dipping in molten metals, etc. The examples provided above are merely meant to illustrate some of the possible materials and techniques that can be employed. Anyone skilled in the art will recognize that any or all of a wide variety of possible materials and techniques, not mentioned here, can be employed without violating the spirit of this invention. Embodiments of this invention thus include binder-depleted cemented carbide articles in which the fine interconnected pore structure, caused by binder depletion, is impregnated or infiltrated with other materials, without regard to the type of material or technique employed, in order to provide certain characteristics or enhance different properties.

Embodiments of this invention include articles that have been made by assembling together binder-depleted cemented carbide components with components made from other materials including metals, alloys, ceramics, precious gems and stones, plastics, wood, etc. Attachment means could include mechanical fastening (for example, screws, bolts, press or shrink fit, etc.), chemical means (epoxy, glue, etc.), brazing, soldering, welding, injection molding, powder metallurgy, casting, etc. The examples provided above are merely meant to illustrate some of the possible materials and techniques that can be employed to form assembled products. Anyone skilled in the art will recognize that any or all of a wide variety of materials and techniques, not mentioned here, can be employed without violating the spirit of this invention. Embodiments of this invention thus include assemblies of binder-depleted cemented carbide components with components made from other materials, without regard to the type of material or attachment technique employed.

The binder-depleted cemented carbide articles of this invention can be employed for a large variety of commercially important applications where the carbide material comes either directly or indirectly into contact with human or animal skin, tissue, organs, etc., or is used to process materials meant for human or animal consumption or ingestion. Embodiments of this invention could include jewelry articles commonly worn by humans based on binder-depleted cemented carbide materials. A very important feature of cemented carbides that make them very attractive for this application is their ability to take on, as well as retain indefinitely, a very fine polish. In addition, the inherent hardness and abrasion resistance of these materials makes them virtually scratch proof. Most other materials used for making jewelry (for example, precious metals such as gold, silver, platinum, etc.) are readily scratched by most materials. Jewelry articles made from precious metals lose their attractiveness very quickly during use and have to be frequently polished. On the other hand, very few materials (for example, diamond, boron carbide, boron nitride, etc.) are harder than cemented carbides, and only these materials are capable of forming scratches on cemented carbide surfaces. Indeed, the only way to grind or polish cemented carbides is with the use of diamond-based grinding wheels and diamond slurries and pastes.

Embodiments of this invention include binder-depleted cemented carbide jewelry articles of any shape and size that can be fabricated using commonly available manufacturing methods for cemented carbides. Embodiments of this invention include jewelry articles such as rings, wedding bands, bracelets, bangles, chains, necklaces, pendants, earrings, ankle bracelets, watchcases, watch straps, etc. Embodiments of this invention also include jewelry articles based on binder-depleted cemented carbides that consist of an assembly of the cemented carbide article and other components. For example, such assemblies could consist of the binder-depleted article having inlays of other materials such as metals, plastics, wood, ceramics, etc. In addition, such assemblies could consist of the binder-depleted cemented carbide articles with inlays of precious gems and stones (example, diamonds, rubies, emeralds, etc.). Embodiments of this invention also include binder-depleted cemented carbide components used to make writing instruments such as fountain pens, ballpoint pens, mechanical pencils, etc.

Until now cemented carbides have not been employed in safety razors used for the removal of facial and body hair, particularly in humans. Normally, cemented carbides would be considered ideal materials from which razor blades could be fabricated because of the exceptional abrasion resistance of these materials, as well as their ability to retain sharp cutting edges during extended service lives. However, the primary reason for their not being used in this application is that, in general, cemented carbide articles are not considered biocompatible due to the presence of Co and/or Ni at and near their surfaces. The removal of the binder at and near the surface, as taught in this invention, make cemented carbide articles biocompatible, and hence, useful as razor blades. Embodiments of this invention thus include binder-depleted cemented carbide razor blades that can be used in either manual razors or electrically operated razors.

Just as in the case of razor blades, cemented carbides would normally be the materials of choice from which surgical instruments would be made. However, since conventional cemented carbides are not biocompatible, they cannot be used to make surgical instruments that come into direct contact with human skin, flesh, organs, bones, etc. Again, the removal of the binder at and near the surface removes the bio-incompatibility limitation of cemented carbides, and hence makes them useful as surgical instruments. Embodiments of this invention thus include surgical instruments based on binder-depleted cemented carbides. Embodiments include surgical instruments such as scalpels, scissors, tweezers, forceps, knives, blades, saws, suture instruments, scalpers, probes, dental instruments, etc.

There are a number of applications involving food preparation, handling, and consumption where cemented carbides would normally be the materials of choice. Examples of such applications include, culinary knives, kitchen and chefs knives, cutlery, choppers and blades used in food processors and blenders, meat grinders, etc. Contact between the food being prepared or consumed could result in the contamination of the food with the binder present at the surface in conventional cemented carbide, thus posing a health hazard to the person consuming the food. On the other hand, removal of the binder at and near the surface of cemented carbide components that come into contact with the food is likely to greatly reduce the risk of contamination. Embodiments of the present invention thus include any hard and abrasion resistant binder-depleted cemented carbide components that can come into contact with food during preparation, processing, handling, and consumption. Food products include animal products, grains, vegetables, etc. The food may be meant for human or animal consumption.

Most pharmaceuticals are sold to the public in the form of pills or tablets. The process for manufacturing such pills and tablets typically involves consolidating the ingredients, which are in powder form, to form a compact that is in the shape of a pill or tablet. The powders are typically compacted in mechanical presses using rigid dies and punches to press the powder. In order to ensure the longevity of the tooling, it is desirable to fabricate the tooling from a material such as cemented carbide. Unfortunately, however, tooling made from conventional cemented carbides could contaminate the pharmaceuticals as the tooling gradually suffers abrasion during the powder consolidation process. This problem can be easily overcome by making the tooling using the binder-depleted cemented carbides of this invention. Embodiments of this invention thus include tooling and other wear components that come into contact with pharmaceuticals during their processing, and made from binder-depleted cemented carbide materials.

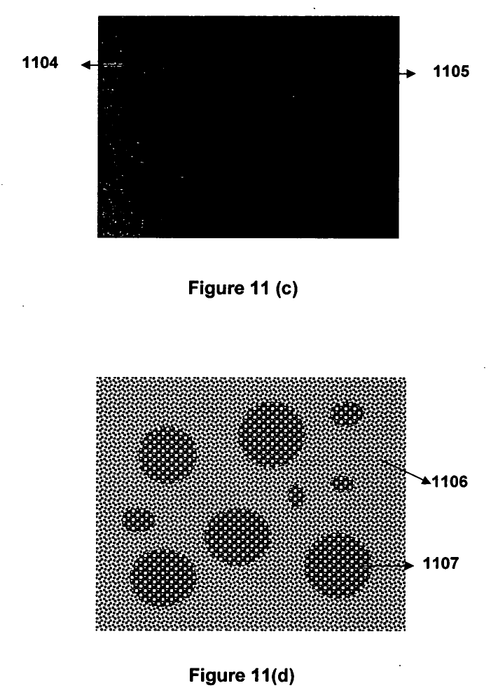

Conventional cemented carbide articles are typically made with a monolithic microstructure, i.e., they have the same composition and grain structure, and hence the same properties, at all locations within the article. A typical monolithic structure is schematically illustrated in FIG. 11(a) based on a single cemented carbide grade 1101. In order to modify or enhance specific properties or characteristics at different locations within the article, it is possible to fabricate the cemented carbide articles with alternative structures, for example, composite, gradient, or hybrid structures. FIG. 11 (b) schematically illustrates a composite structure wherein the cemented carbide article is made using two or more different grades, namely 1102 and 1103. In this manner, it is possible to enhance properties such as abrasion resistance at some locations on the article, while maintaining a high fracture toughness at another location in the article. FIG. 11(c) schematically illustrates a gradient structure made using two different grades, namely, 1104 and 1105. In gradient structures the properties change gradually (rather than abruptly as in the case of composite structures). Also, FIG. 11(d) schematically illustrates a hybrid structure made by combining two or more different grades, namely 1106 and 1107, of cemented carbides as shown. Embodiments of this invention include binder-depleted cemented carbide articles based on monolithic, composite, gradient, and hybrid microstructures.

It is to be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of the present invention have been described, one of the ordinary skill in the art will, upon considering the foregoing description, recognize that many modifications and variations of the invention may be employed. All such variations and modifications of the invention are intended to be covered by the foregoing description and the following claims.

1. Cemented carbide jewelry articles comprising:
one or more carbides of the transition metals belonging to groups IVB, VB, and VIB of the periodic table (Ti, V,Cr, Zr, Mo, Nb, Hf, Ta, or W) or solid solutions of the carbides; and
a metallic binder consisting of Co, Ni, or Fe or alloys of these metals; and
a binder depleted zone that is impregnated with low melting point materials selected from the family of materials including waxes, epoxies, teflon, plastics, polymeric materials, oils, etc, or alternately, infiltrated with metals selected from the family of metals including Au, Ag, Pt, Ti, Cu, Al, Cr, Mn, Zn, and Sn, and alloys of these metals.

2. The articles of claim 1 wherein the transition metal carbides comprise between 50 and 98 weight percent of the article and the binder comprises between 2 and 50 weight percent.

3. The articles of claim 1 wherein the article is made with a monolithic, composite, gradient, or hybrid microstructure.

4. The articles of claim 1 on which a single coating, or multiple hard coatings of one or more compounds, have been applied on one or more surfaces of the article, the coatings being selected from the family of compounds including TiN, TiC, TiCN, TiAIN, Al2O3, and Diamond Like Coating (DLC), and applied using chemical vapor deposition (CVD), physical vapor deposition (PVD), or combinations of these methods.

5. (canceled)

6. The articles of claim 1 assembled together with one or more other articles made from metals and alloys, wood, plastics, ceramics, and precious gems and stones, employing one or more assembly techniques selected from the group consisting of screwed or bolted joints, shrink fit, press fit, joints formed using adhesives or glues, welding, brazing, soldering, injection molding, powder metallurgy, and casting.

7. Cemented carbide surgical instruments and razor blades comprising:
one or more carbides of the transition metals belonging to groups IVB, VB, and VIB of the periodic table (Ti, V,Cr, Zr, Mo, Nb, Hf, Ta, or W) or solid solutions of the carbides; and
a metallic binder consisting of Co, Ni, or Fe or alloys of these metals; and
a binder depleted zone that is impregnated with low melting point materials selected from the family of materials including waxes, epoxies, Teflon, plastics, polymeric materials, oils, etc, or alternately, infiltrated with metals selected from the family of metals including Au, Ag, Pt, Ti, Cu, Al, Cr, Mn, Zn, and Sn, and alloys of these metals.

8. The articles of claim 7 wherein the transition metal carbides comprise between 50 and 98 weight percent of the article and the binder comprises between 2 and 50 weight percent.

9. The articles of claim 7 wherein the article is made with a monolithic, composite, gradient, or hybrid microstructure.

10. The articles of claim 7 on which a single coating, or multiple hard coatings of one or more compounds, have been applied on one or more surfaces of the article, the coatings being selected from the family of compounds including TiN, TiC, TiCN, TiAIN, Al2O3, and Diamond Like Coating (DLC), and applied using chemical vapor deposition (CVD), physical vapor deposition (PVD), or combinations of these methods.

11. (canceled)

12. The articles of claim 7 assembled together with one or more other articles made from metals and alloys, wood, plastics, and ceramics, employing one or more assembly techniques selected from the group consisting of screwed or bolted joints, shrink fit, press fit, joints formed using adhesives or glues, welding, brazing, soldering, injection molding, powder metallurgy, and casting.

13. Cemented carbide cutting instruments and wear components used in the processing, handling, and consumption of foodstuffs and pharmaceuticals comprising:
one or more carbides of the transition metals belonging to groups IVB, VB, and VIB of the periodic table (Ti, V,Cr, Zr, Mo, Nb, Hf, Ta, or W) or solid solutions of the carbides; and
a metallic binder consisting of Co, Ni, or Fe or alloys of these metals; and
a binder depleted zone that is impregnated with low melting point materials selected from the family of materials including waxes, epoxies, Teflon, plastics, polymeric materials, oils, etc, or alternately, infiltrated with metals selected from the family of metals including Au, Ag, Pt, Ti, Cu, Al, Cr, Mn, Zn, and Sn, and alloys of these metals.

14. The articles of claim 13 wherein the transition metal carbides comprise between 50 and 98 weight percent of the article and the binder comprises between 2 and 50 weight percent.

15. The articles of claim 13 wherein the article is made with a monolithic, composite, gradient, or hybrid microstructure.

16. The articles of claim 13 on which a single coating, or multiple hard coatings of one or more compounds, have been applied on one or more surfaces of the article, the coatings being selected from the family of compounds including TiN, TiC, TiCN, TiAlN, Al2O3, and Diamond Like Coating (DLC), applied using chemical vapor deposition (CVD), physical vapor deposition (PVD), or combinations of these methods.

17. (canceled)

18. The articles of claim 13 assembled together with one or more other articles made from metals and alloys, wood, plastics, and ceramics, employing one or more assembly techniques selected from the group consisting of screwed or bolted joints, shrink fit, press fit, joints formed using adhesives or glues, welding, brazing, soldering, injection molding, powder metallurgy, and casting.
